(19) United States
(12) Patent Application Publication
(10) Pub. No.: US 2007/0245647 A1
(43) Pub. Date: Oct. 25, 2007

(54) Windows accessory no draft kit

(76) Inventor: Leon Glenn, Union City, GA (US)

Correspondence Address: Leon Blenn;# 27 B, 4701 Flat Shoals Rd., Union City, GA, 30291, US

(21) Appl. No.: 11/400,258

(22) Filed: Apr. 8, 2006

(51) Int. Cl. E06B 3/26

(52) U.S. Cl. 52/202

(57) ABSTRACT

This kit stops the draft that comes trough the old windows and glass sliding doors. It is a quick and easy way of changing a single pane window to a double. This product ellemates the high cost of installing new double pain windows or storm windows, for less than a ⅓ of cost. It is a vinyl sheeting that comes in various colors of tint as well as transparent. The tented vinyl sheeting also helps keep out the suns ultra violet rays. Stopping these rays, stops the discoloring of your drapes, curtains and furniture. It is an all season product that keeps the cold air of winter out, and the hot air of the summer from coming in. Its helps with your energy bill. By sealing off these areas of your home or office with this product, gives you about a bout a 40% savings. It all made of durable plastic. It takes on average of about 20 minute per window to install. Its works good in antic or older homes, by keeping the authenticity of the home up and energy cost down.

### MATERIAL

Vinyl Sheeting

Reusable, Clear, non-yellowing,
Stays flexible in cold weather.
4 MIL Or thicker, (Optional)
   Velcro
General Purpose Adhesive
¾″ wide
Various colors, Optional
(Velcro can be replace with magnetic strips for metal frames windows, both applications are self adhesive.)
   L Bracket
1″ Hard plastic (Length varies with window)
You can screw or glue L bracket to window
(L bracket can be replace with metal for magnetic strips)
   Rubber Text Foam
1″ Thick
   Latex calking

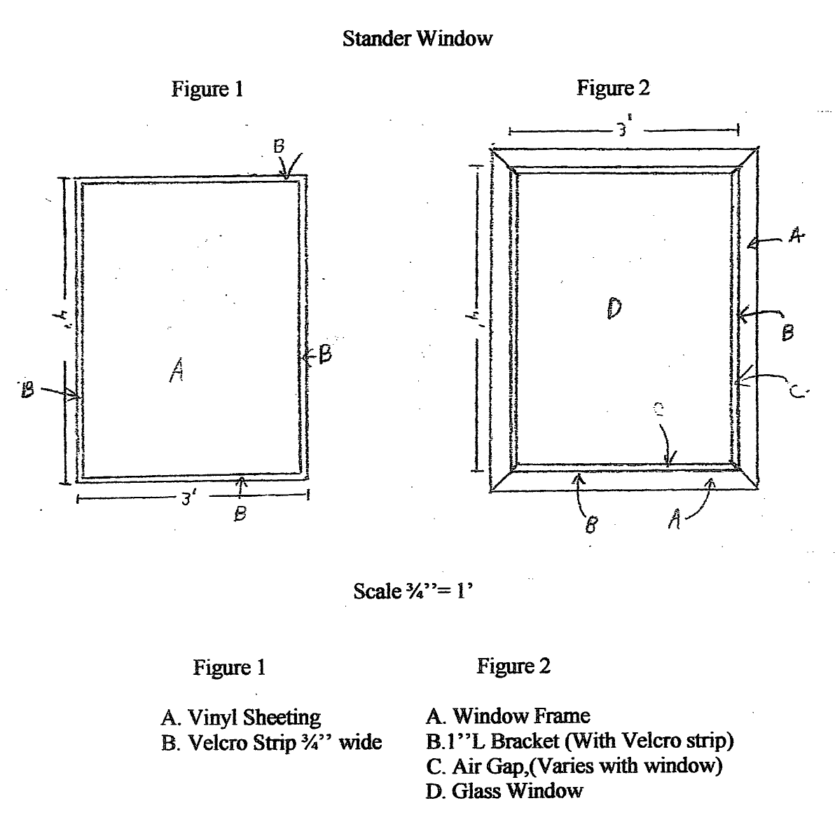

FIG. 1

A 4′×3′ roll of Vinyl Sheeting, transparent and covered with Velcro all along the borders, edges . . . , All though transparent, it dose have several tents or shades that's optional, from a dark to a lighter vinyl sheeting, with various colors. This vinyl sheeting fits all shapes of windows, because its Cut to fit the L brackets.

FIG. 2

A standard 3′×4′ window.

This drawing indicator where the L brackets go, or where you want to install it. I believe that the more space you have between the existing window and the vinyl sheeting, the more efficient it is at saving every.

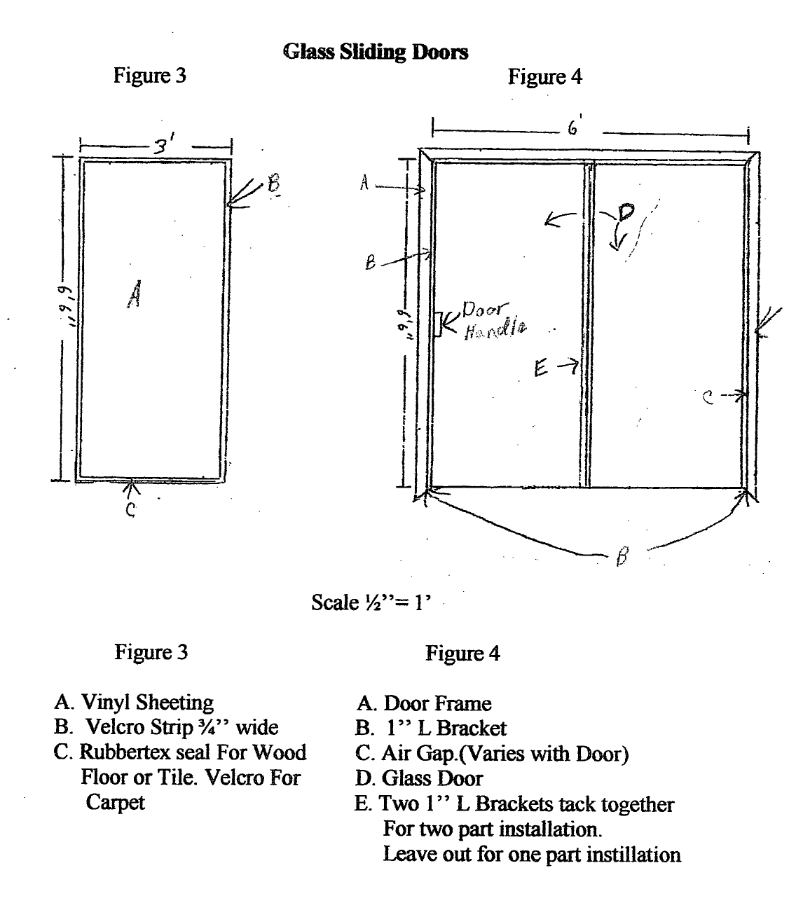

FIG. 3

A 6′6″×3′ roll of vinyl sheeting, transparent and covered with Velcro all along the edges, this drawing indicates the 2 part installation. This application all so comes in various shades of vinyl sheeting.

FIG. 4

### Sliding Double Doors

This drawing indicates where the L brackets go or where you want to install it. Sliding doors can have a 1 or 2 part vinyl sheeting. Add double L bracket down the middle of doors, top to bottom, tack two L brackets together in a T shape for the 2 part application. To keep walk way clear for safety, the L bracket is not screwed or glued to floor. It is seal with rubber text foam that's press against floor. This application is for tile and wood floors.

### INSTALLATION DIRECTION

1. Install L bracket all around window. Cut it to fit tight. It can be glued or screw in. (Allowing for wide enough gap so that screen don't interfere with window or door handle)

2. Glue Velcro strip on L bracket. Install second part of Velcro strip to first strip of Velcro on L bracket. Precut windows vinyl sheeting to fit L brackets, but over cut it about 1″. Then place it to the back side of the second part of Velcro strips in window. Then cut off excesses vinyl sheeting.

### Accessing Window

By adding a piece of Velcro, about 2″ long to the top finish part of windows Accessory in the upper corners, allows you to roll up windows accessory. And stick it to the 2″ strips, allowing it to hang in window. Or you can simply take it out. By adding this 2″ strip to all 4 canners makes it possible to role the vinyl sheeting various ways.

### Do Not Fold Windows Accessory

It will leave a crease in it. Roll it up tightly and put in vinyl sheeting. storage bag. This will lesson the chance of putting creases in the vinyl sheeting.

### Tolls

Tin snipes or scissors

Fillip screw drivers,

Utility knife

What I claim as my invention is:

1. It's is the first of its kind, that offers a quick and easy way of installing your window. It is an all season kit. It saves on heating and cooling bills. It is a vinyl sheeting that goes inside the window seals and door frames. Because of the way it is assemble and installed, will make it a very common house hold product, which will make some home owners think or hold back on the purchase of new windows. It will intervene with the window sales industry. A product like this should have a paten. I have not seen an application like this any where. It's the first application of it's kind. In the 4 years I've been involve in this project, a vast number of people have also said that my application is new. That the way it works is amazing, The pubic out cry for this product in overwhelming, these are the reason that I'm trying to inter the market.
